(19) United States
(12) Patent Application Publication
(10) Pub. No.: US 2005/0100155 A1
(43) Pub. Date: May 12, 2005

(54) Call distribution in distributed call centers

(76) Inventors: Marian Trinkel, Untermaubach (DE); Reinhard Seidel, Ulm (DE); Stefan Raab, Neu-Ulm (DE); Werner Danzer, Ulm (DE)

Correspondence Address: KENYON & KENYON, ONE BROADWAY, NEW YORK, NY, 10004, US

(21) Appl. No.: 10/362,670

(22) PCT Filed: Aug. 4, 2001
(86) PCT No.: PCT/EP01/09041

(30) Foreign Application Priority Data
Aug. 17, 2000 (DE) 100 40 301.8

(51) Int. Cl. H04M 7/00

(52) U.S. Cl. 379/220.01

(57) ABSTRACT

A method and/or system for receiving or accepting and processing calls within a telephone network having lines, including a voice and a data channel, for connecting a caller to subscriber groups connected to the network. A subscriber group has an assigned network identifier via which all members of the subscriber group are able to be called by a caller. The calls intended for one subscriber group are distributed via a control to the individual members of the group on the basis of specifiable criteria, data records assigned to one connection being exchanged via the data channel, and the control being carried out by a control unit which is integrated in the network and has access to complete data records. A subscriber group may have an assigned control unit which automatically decides on the connection of a call to a special member of the group.

### FIELD OF THE INVENTION

The present invention relates to a method and/or device for an intelligent contact manager.

### RELATED TECHNOLOGY

One use of an “intelligent” networks is to make special subscriber groups, in particular “call centers”, such as telephone information services, available to the subscribers within such a network, a plurality of call centers being distributed in decentralized fashion over the network, and a call center being assigned to the subscribers of a specific region. Structures of this kind may be available from large mail-order firms. Thus, for example, a telephone information service is organized in such a way that a large number of call centers, which are distributed in decentralized fashion over the region of the network, are able to be reached from everywhere via one single phone number. However, in order for the customer, as the caller, to reach the local call information service responsible for him/her, the customer's call is switched via the data channel to a centrally established control unit, which is set up as a server of the network and which, on the basis of the customer's telephone number (network identifier), assigns a local call information service to the customer and then connects his/her voice channel to the appropriate local call center. The access to other networks, such as cellular networks, is organized in similar fashion. Simple telephone systems having a plurality of connections also form such a group.

In using available methods, the organization within the group is only able to profit conditionally from the “intelligence” of the network. Control units used until now merely form an interface to the network, however, without themselves belonging to the network, which would give them access to the complete data records transmitted over the data channel. For reasons of data protection, a large part of the information is lost. From this, for example, the available control units merely distribute the calls, without considering background information on the individual members. It can happen in decentralized call centers, that one center is overloaded at times, and its customers are put on a wait or holding loop for long periods of time, or are even dismissed with a busy signal, while another center has available capacity at that very time. These problems lead to a poor utilization of existing capacities and, above all, to customer dissatisfaction.

Further, the network provider makes available the control units and, for reasons of network compatibility with the intranets of the subscriber group, it must also configure them in accordance with the requirements of these intranets. This organizational work is labor-intensive, and problems may arise due to the wide disparity in the organizations of the individual groups, due, for example, to different communications protocols. Moreover, structures of this kind are rigid and are not able to react flexibly to organizational changes in the group. Further, the connections within one group are organized via the network, which may put an excessive burden on the network. The network, which has nothing to do with the actual autonomous group, must nevertheless concern itself with the organization of the group, since the control is centrally located within the network.

### SUMMARY OF THE INVENTION

Exemplary methods and/or exemplary systems of the present invention are directed to using simple and cost-effective means to make a service available to subscriber groups for them to conveniently use for their internal organization, and which, by using extensive background information, may lead to a more flexible organization of the subscriber groups, thereby ultimately relieving the network and the network provider.

Further exemplary methods and/or exemplary systems of the present invention are directed to receiving, or accepting, and processing calls within a telephone network having lines, including a voice and a data channel, for connecting a caller to subscriber groups connected to the network, a subscriber group having an assigned network identifier via which all members of the subscriber group are able to be called by a caller; the calls intended for one subscriber group being distributed via a control to the individual members of the group on the basis of specifiable criteria, and data records assigned to one connection being exchanged via the data channel.

Exemplary methods and/or exemplary methods of the present invention are directed to so-called “intelligent” telephone networks in which the lines not only have channels for transmitting voice messages, but also have parallel data channels on which background information, such as caller identification, is transmitted. These data channels may be combined in one or more central servers which are able to process the background information and which ultimately decide on the establishment of the voice channels.

Exemplary methods and/or exemplary systems of the present invention are directed to integrating the control units, available till now and implemented, for example, by the individual phone systems and/or by distribution systems of external networks, in the “intelligent” network. While from the related art, outsiders may regard the network as a closed entity, and to only use the interfaces provided to connect control units. Exemplary methods and/or exemplary systems of the present invention are directed to implementing the control units by computers of the “intelligent” network itself. These then may have access to all the information available to the network provider. Thus, the present invention may be realized, in particular, by the network provider himself, who knows his network from the inside. The control operation may be carried out by a control unit which is integrated in this manner in the network. It not only has access to the abbreviated data records, but to the complete data records and, thus, to the entire background information. In this context, a control unit, which may be part of a central unit, may be assigned to a subscriber group, the control unit automatically deciding on the connection of a call to a special member of the group. Thus, the network-integrated control unit may assume the role of distribution node for the subscriber group. Accordingly, the need is eliminated for the previously necessary, data loss-producing interface (“communication interface”) to the distribution node, since the distribution node is implemented by the network itself.

In exemplary methods and/or exemplary systems of the present invention, the intelligence of the telephone network may be present in the control unit, and it may be utilized by the subscriber group. This renders possible technically simpler design approaches for the individual control units, which may be sold or leased as compact systems (routers) by the network provider to the subscriber group. The router may decide independently about connecting a call to a special member of the group. A computer (or server) may be used as the router, and thus as the control unit.

In further exemplary methods and/or exemplary systems according to the present invention, to be able to assume this function, the control unit must also receive information from the group. This information may be transferred by the customer, thus the operator of the customer group, to the network provider in a type of traffic management protocol. On the basis of this protocol, the control unit may distribute the incoming calls. In this context, the network provider may implement the protocol in the control unit. In further exemplary methods and/or exemplary systems according to the present invention, the customer may load his special protocol himself, using a data line, onto the control unit.

The term “subscriber group” is used quite generally. Thus, the aggregate of telephone information service centers connected to the network, or an autonomous network, such as a cellular network that is accessible via the primary network, or even a telephone system having a plurality of separately dialable connections, may constitute a subscriber group along the lines of the present invention.

In further exemplary methods and/or exemplary systems according to the present invention, since a group may have one individual control unit available to it, via the decentralized organization—which, to a certain extent, is centrally organized—a substantially more flexible response to the needs of the group is possible than in the case of available central controls. For example, rate structures may be simply adapted. Moreover, the primary network may be relieved of the task of organizing the group, thereby freeing up available capacity. Exemplary methods and/or exemplary systems according to the present invention may further provide that heterogeneous, modal and medial networks may now be simply coupled. In this context, the present invention, which is also manifested in the routers being made available, is suited, in its modularity, for mass applications. Further exemplary methods and/or exemplary systems according to the present invention may further provice that the existing infrastructure of the “intelligent” network and the existing call center may be used, and, for each group, it is merely necessary to set up one control unit on one server. Thus, the cost advantages may be evident; and, the service may be clearly improved for the customer.

In further exemplary methods and/or exemplary systems according to the present invention, in the context of the criteria predefined for the control unit, the caller's identifier may be considered as an indication of his location. This means that the control unit may primarily attempt to establish a connection to the member who is locally responsible for the caller. In further exemplary methods and/or exemplary systems according to the present invention, the capacity utilization of any one member may be registered by the control unit, and the calls are distributed to the individual members on the basis of the overload criterion. If the control unit ascertains a singular overload, it may switch the incoming call to another member (center). In this manner, to the outside, a group of such service providers represents a single provider, which is also dialed via one central number, there being a certain local relationship nevertheless. This local relationship can be useful for a customer, since a caller from one city may feel better advised by a local advisor than if he/she were to be switched to another city.

Moreover, in further exemplary embodiments and/or exemplary systems of the present invention, for the criteria, one may consider whether it is worthwhile in the individual case, to be rerouted by the responsible center to the alternative center, or whether the cost disadvantages of the longer line are the preponderant consideration. It may be foreseeable that the subscriber has just arrived at the end of the wait or holding loop, so that a minimal wait loop can be reasonably asked of him/her.

In exemplary methods and/or exemplary systems according to the present invention, private networks, such as the service network of automobile dealers which have a multiplicity of local branches, may also be optimized via the control unit. In this context, a control unit made available by the network operator may service a large number of such centers combined into groups. In further exemplary methods and/or exemplary systems according to the present invention, since the calls are centrally distributed with respect to the group, it may be possible to adapt the switching service to the customer profile.

In the exemplary methods and/or exemplary systems according to the present invention, the service may be improved with respect to the customer. This can strengthen the customer's ties to the network operator. In addition, a modular and flexible expansion of the technology may be possible, depending on the particular requirement. In this context, a clean separation of the responsibilities of the network, on the one side, and of the group, on the other side, may be ensured. Each group may implement its own performance features within the group. Due to the many individual degrees of freedom, the organization in accordance with the present invention may be easily regulated.

### BRIEF DESCRIPTION OF THE DRAWINGS

FIG. 1 shows a group of subscribers integrated in a data line network.

FIG. 2 shows a group of subscribers linked to a data line network.

FIG. 3 shows a control unit.

### DETAILED DESCRIPTION

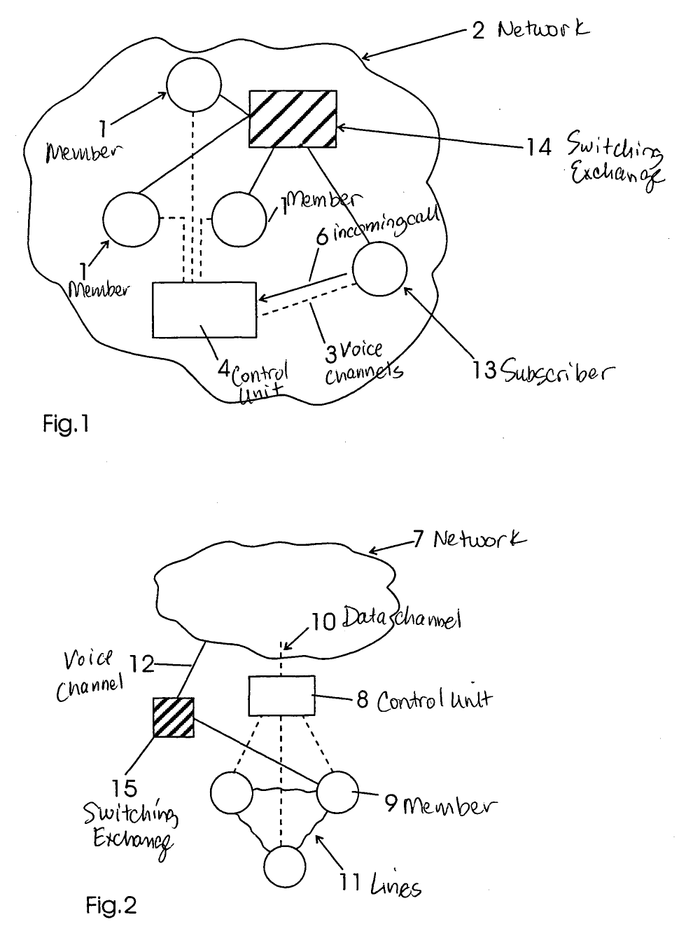

FIG. 1 shows three members 1 forming a subscriber group, the members being individual telephone information service centers, for example. These members 1 are integrated in an external “intelligent” network 2 and, accordingly, are interconnected via voice channels (solid lines) 3 of the lines of network 2 via a switching exchange 14. Likewise integrated in network 2 may be a subscriber 13 who does not belong to the group. The group may be defined by a control unit 4, which is integrated in network 2 and, in this case, is a central control unit 4 to which at least subscriber 13 is still connected. The connection to control unit 4 can be established via data channels (dotted lines) 3, which converge on control unit 4. In this example, control unit 4 is a server of the intelligent network. Control unit 4 is itself accessible via network 2 and may be dialed via its network identifier (e.g., a service phone number) by subscriber 13. In response to an incoming call (arrow 6), control unit 4, which, as part of network 2, is informed about the momentary capacity utilization of individual members 1, decides to which member the call is switched through, switching exchange 14 looping the call via the voice channels.

FIG. 2 illustrates a network 7 having subscribers. Linked to network 7 is a control unit 8, which forms an interface, integrated in network 7, to a group of members 9 and which may be dialed from network 7 via network-internal data channel 10. The group, in turn, forms a network, for example, a cellular network, individual members 9 being able to communicate with one another via lines (waiting queues) 11. A call intended for a member 9, from network 7, is initially organized by control unit 8 through data channels 10, before a voice channel 12 is switched through via switching exchange 15 to subscriber 9.

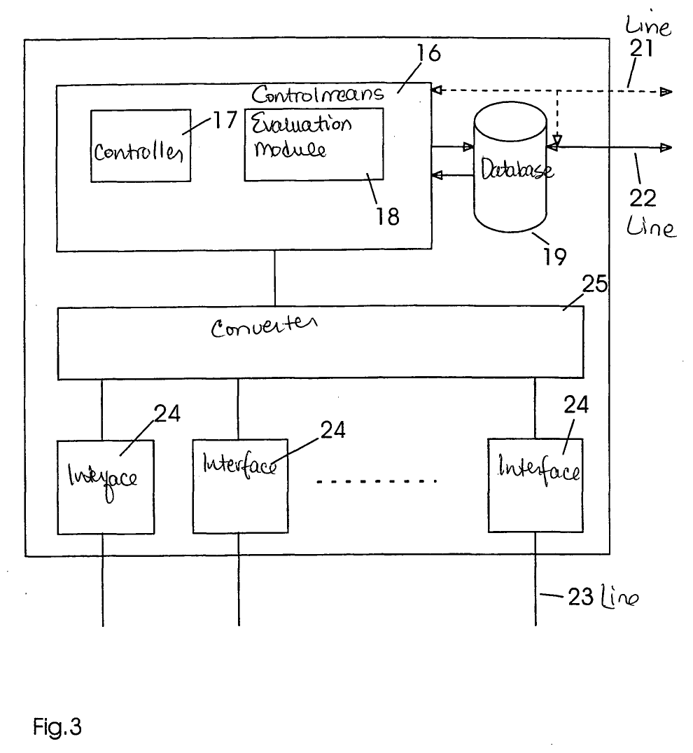

In FIG. 3, control unit 4 is schematically shown having a control means 16 including controller 17 and an evaluation module 18. Control means 16 has access to a database 19, in which, via interface 20, data from the telecommunications network may be able to be stored. Interface 20 has a data line 21, via which a direct communication between control means 16 and the network is possible. The communication takes place with the inclusion of database 19, via line 22. The connection to the subscriber groups is made via lines 23, which each lead from a suitable interface 24 to the outside world. Between the subscriber groups and the telecommunications network, a converter 25, which may be likewise implemented on control unit 4, may be needed to convert the individual protocols.

1-11. (canceled)

12. A method for receiving and processing calls within a telephone network having lines, including a voice and a data channel, for connecting a caller to subscriber groups connected to the network, a subscriber group having an assigned network identifier via which all members of the subscriber group are able to be called by a caller, the calls intended for one subscriber group being distributed via a control to the individual members of the group on the basis of specifiable criteria, and data records assigned to one connection being exchanged via the data channel, wherein the control is carried out by a control unit which is integrated in network and has access to complete data records, a subscriber group having an assigned control unit which automatically decides on the connection of a call to a special member of the group.

13. The method as recited in claim 12, wherein service providers having a plurality of decentralized branches or network providers having a multiplicity of connections make up the subscriber groups.

14. The method as recited in claim 12, wherein the capacity utilization of any one member is registered by the control unit, and the calls are distributed on the basis of the overload criterion to the members.

15. The method as recited in claim 12, wherein in the criteria, the caller's identifier is considered as an indication of his location, and a connection is established to the member (1,9) who is locally responsible for the caller.

16. The method as recited in claim 12, wherein a cost-benefit calculation is considered in the criteria with regard to rerouting the call.

17. A telephone network having a multiplicity of subscribers, who are able to be connected to one another via the network, and having subscriber groups, which include a plurality of members and which are able to be dialed via a common network identifier assigned to a group, the subscribers being able to be connected among themselves or to a subscriber group via lines which include a voice and a data channel, data records assigned to one connection to be established being exchanged via the data channel, characterized by control units, which are integrated in the telephone network and which control the establishment of the connections among the subscribers and individual members of a subscriber group and which have access to complete data records, an individual subscriber group having an assigned control unit, which is able to be dialed via the network identifier of the subscriber group and which connects the subscriber placing the call to one subscriber of the group.

18. The network as recited in claim 17, wherein a control unit forms an interface between network and the subscriber group, which processes both the protocol of the network as well as the protocol of the group.

19. The network as recited in claim 18, wherein the control unit has a converter module which converts the protocol of the subscriber group into the protocol of the data line network.

20. The network as recited in claim 17, wherein the members of a group are interconnected via the data line network.

21. The network as recited in claim 17, wherein the members of a group are interconnected via a separate network.

22. The network as recited in claim 17, wherein a computer forms the control unit.
